(19) United States
(12) Patent Application Publication
(10) Pub. No.: US 2013/0182056 A1
(43) Pub. Date: Jul. 18, 2013

(54) INKJET RECORDING INK, INK CARTRIDGE, AND INKJET RECORDING DEVICE

(71) Applicants: Naoya MOROHOSHI, Shizuoka (JP); Mitsuru Naruse, Shizuoka (JP); Minoru Hakiri, Shizuoka (JP)

(72) Inventors: Naoya MOROHOSHI, Shizuoka (JP); Mitsuru Naruse, Shizuoka (JP); Minoru Hakiri, Shizuoka (JP)

(21) Appl. No.: 13/742,864

(22) Filed: Jan. 16, 2013

(30) Foreign Application Priority Data
Jan. 17, 2012 (JP) 2012-7376

(51) Int. Cl. C09D 11/00; B41J 2/175

(52) U.S. Cl. CPC C09D 11/30; B41J 2/17503
USPC 347/100; 524/547; 524/496; 524/495; 428/195.1; 428/211.1

(57) ABSTRACT

An inkjet recording ink including water; a dispersant containing a block type copolymer having structural unit of a diene monomer and an aromatic vinyl monomer, wherein the block type copolymer has a sulfonic acid group or salt thereof; a first carbon black; and a second carbon black having 2.0 μmol/m² to 5.0 μmol/m² of a carboxyl group on a surface thereof.

### CROSS-REFERENCE TO RELATED APPLICATIONS

This patent application is based on and claims priority pursuant to 35 U.S.C. §119 to Japanese Patent Application No. 2012-7376, filed on Jan. 17, 2012, in the Japan Patent Office, the entire disclosure of which is hereby incorporated by reference herein.

### BACKGROUND OF THE INVENTION

1. Field of the Invention

The present invention relates to an inkjet recording ink, an ink cartridge, and an inkjet recording device.

2. Description of Related Art

Inkjet recording pigment inks are generally prepared by preliminarily dispersing a pigment and a dispersant in an aqueous solvent such as water and alcohols to produce a dispersion liquid, next dispersing the dispersion liquid using a media-type dispersing device such as a sand mill, and then diluting the dispersion liquid to a specific concentration.

In a water-based pigment ink, a dispersant such as surfactant or water-soluble resin is used for dispersing a hydrophobic pigment.

For example, Patent Literature (PTL) 1, Japanese Patent Application Laid-Open (JP-A) No. 2008-63573, discloses a pigment dispersion containing at least carbon black, a dispersant and water, wherein the carbon black is at least either of channel black or gas black, the dispersant is a sodium naphthalenesulfonate formalin condensate.

PTL 2, JP-A No. 2009-67907, discloses an inkjet recording ink consisting essentially of a carbon black, a dispersant, anionic self-emulsification type ether-based polyurethane resin particles and water.

PTL 3, JP-A No. 2009-173805, discloses an ink for inkjet recording containing at least carbon black, a dispersant, polyurethane resin particles and water, wherein the carbon black is channel black and/or gas black, the polyurethane resin particles are anionic self-emulsification type ether-based polyurethane resin particles.

PTL 4, JP-A No. 2006-160950, discloses an aqueous pigment dispersion comprising water, a pigment, and a polymer dispersant of 30-100 wt % to the pigment, the polymer dispersant is obtained by neutralizing a styrene-(meth)acrylic acid-based copolymer, whose acid value is 160-300 mg KOH/g and weight average molecular weight is 8,000-20,000.

PTL 5, JP-A No. 2005-255739, discloses a method for producing the aqueous pigment dispersion comprising dispersing a pigment in an aqueous medium in the presence of a polymer which is a (co)polymer comprising structural units derived from a diene monomer or a hydrogenation product of the (co)polymer and has sulfonic acid (salt) groups and a water-soluble organic solvent such as an alcohol compound or a glycol ether compound.

PTL 6, JP-A No. 2007-16104, discloses a water-based carbon black dispersion containing a (co)polymer containing a diene-based monomer as a constituent unit, and having a sulfonic acid (salt) group, and/or a hydrogenated product thereof.

PTL 7, JP-A No. 2008-163132, discloses a water-based carbon black dispersion containing a (co)polymer containing a constitution unit derived from a diene based monomer and having a sulfonic acid base or its salt and/or its hydrogenation substance, a carbon black having a DBP absorption amount of 250 ml/100 g or higher, and a carbon black having a DBP absorption amount of less than 250 ml/100 g.

Meanwhile, a method for dispersing the pigment without using the dispersant is proposed. For example, PTL 8, U.S. Pat. No. 5,571,311, discloses an aqueous ink jet ink composition comprising an aqueous vehicle and a carbon black product attached to at least one organic group. The organic group comprises at least one aromatic group and at least one ionic group, at least one ionizable group, or a mixture of an ionic group and an ionizable group.

PTL 9, JP-A No. 08-81646, discloses ink containing (A) a water-soluble monomer (e.g., N-acryloylmorpholine, 5-20 wt. % to a dispersion medium), (B) a water-insoluble monomer (e.g., styrene, a total amount of the components A and B is 5-20 pts.wt.), (C) carbon black having the surface on which the components A and B are graft-polymerized (e.g., primary particle diameter is 15-40 nm) and (D) an aqueous medium dispersing the component C.

PTL 10, JP-A No. 08-3498, discloses a water-based pigment ink comprising water and carbon black, wherein the carbon black used is carbon black having a surface active hydrogen content of 1.5 mmol/g or more.

PTL 11, JP-A No. 2000-239589, discloses an ink containing the first pigment and the second pigment as coloring materials in an aqueous medium in a dispersed state.

PTL 12, JP-A No. 2009-149815, discloses an ink for inkjet recording comprising: a pigment dispersion liquid (A) containing at least carbon black, a dispersant, and water; and a self-dispersion type pigment dispersion liquid (B) containing carbon black having surface functional groups.

The inventors investigated and evaluated the properties of the inks disclosed in PTL 1 to PTL 12 as described below.

The ink disclosed in PTL 1 does not provide images having enough image density in printing on a plain paper, and the ink does not have enough preservation stability. The ink disclosed in PTL 2 or PTL 3 does not provide images having enough image density in printing on the plain paper. The ink disclosed in PTL 4 does not provide images having enough image density in printing on the plain paper, and the ink does not have enough preservation stability. The ink disclosed in PTL 5 does not provide images having enough image density in printing on the plain paper. The ink disclosed in PTL 6 or PTL 7 does not have enough preservation stability and enough jetting stability. The ink disclosed in PTL 8 or PTL 9 does not provide images having enough image density in printing on the plain paper, particularly when the surface tension of the ink is not more than 35 mN/m, at 25° C. The ink disclosed in PTL 10 does not provide images having enough image density in printing on a gloss paper. The ink disclosed in PTL 11 does not have enough preservation stability. The ink including sodium naphthalenesulfonate formalin condensate as the dispersant, disclosed in PTL 12, does not have enough preservation stability. This research led to development of a new inkjet ink that solves the problems of prior art inkjet inks.

### SUMMARY OF THE INVENTION

The present invention provides an inkjet recording ink, which produces images having high image density on both plain paper and gloss paper, and has excellent jetting stability and excellent preservation stability.

The inkjet recording ink, which is the means for solving the aforementioned problems, comprises water; a dispersant containing a block type copolymer having structural unit of a diene monomer and an aromatic vinyl monomer, wherein the block type copolymer has a sulfonic acid group or salt thereof; a first carbon black dispersed by the dispersant; and a second carbon black having 2.0 μmol/m² to 5.0 μmol/m² of a carboxyl group on a surface thereof.

The present invention provides an inkjet recording ink, which provides images having high image density on either plain paper or paper having a gloss, while having excellent jetting stability and preservation stability.

### BRIEF DESCRIPTION OF THE DRAWINGS

FIG. 1 schematically shows an example of a casing of an ink cartridge.

FIG. 2 schematically shows an exterior of the ink cartridge of FIG. 1 including the casing thereof.

FIG. 3 shows a perspective view of an inkjet recording apparatus.

FIG. 4 schematically shows an example of an entire construction of the inkjet recording apparatus.

### DETAILED DESCRIPTION OF THE INVENTION

The embodiments of the present invention will be described in detail. The embodiments comprise <1> to <4> as described below.

<1> An inkjet recording ink including: water; a dispersant containing a block type copolymer having structural unit of a diene monomer and an aromatic vinyl monomer, wherein the block type copolymer has a sulfonic acid group or salt thereof; a first carbon black dispersed by the dispersant; and a second carbon black having 2.0 μmol/m² to 5.0 μmol/m² of a carboxyl group on a surface thereof.
<2> The inkjet recording ink according to <1>, including, a first pigment dispersion liquid containing water, the dispersant, and the first carbon black; and a second pigment dispersion liquid containing water and the second carbon black; wherein the second pigment dispersion liquid has an electron conductivity of 0.6 mS/cm to 1.8 mS/cm.
<3> An ink cartridge including: a container containing the inkjet recording ink as defined in any one of <1> or <2>.
<4> An image forming apparatus including: the ink cartridge as defined in <3>; and an ink ejector ejecting the inkjet recording ink to form an image.

### <Inkjet Recording Ink>

The inkjet recording ink of this embodiment includes water; a dispersant containing a block type copolymer having structural unit of a diene monomer and an aromatic vinyl monomer, wherein the block type copolymer has a sulfonic acid group or salt thereof; a first carbon black dispersed by the dispersant; and a second carbon black having 2.0 μmol/m² to 5.0 μmol/m² of a carboxyl group on a surface thereof.

The inkjet recording ink is made from a pigment dispersion liquid A including the first carbon black as a pigment, the dispersant, and water; and a pigment dispersion liquid B including the second carbon black as a pigment and water.

### <Pigment Dispersion Liquid A>

The pigment dispersion liquid A contains at least the first carbon black, the dispersant, and water, as well as further other components as required. Examples of the first carbon black include those manufactured by gas black method, furnace method, and channel method.

For the first carbon black, commercially available products can be used. The examples of the commercially available products for the first carbon black include #45L, MCF88, #990, MA600, and #850 (manufactured by Mitsubishi Chemical Corporation); NIPEX90, NIPEX150, NIPEX160, NIPEX170, NIPEX180, COLOR BLACK FW200, PRINTEX25, and SPECIAL BLACK250 (manufactured by Degussa Japan Co., Ltd.); and REGAL400R, REGAL600R, and MOGUL L (manufactured by Cabot Corporation). Such commercially available products include those described in the most recent versions of the manufacturer or supplier catalogs or product literature which are incorporated by reference.

The average primary particle diameter of the first carbon black is preferably 10.0 nm to 30.0 nm, and more preferably 15.0 nm to 20.0 nm. The BET specific surface area of the first carbon black is preferably 100 m²/g to 400 m²/g, and more preferably 150 m²/g to 300 m²/g.

The average primary particle diameter can be calculated based on particle diameter and particle number in a photographed image of the first carbon black, which is photographed by using an electron microscope, for example. The BET specific surface area of the first carbon black can be measured by BET method using nitrogen adsorption.

The first carbon black is weak in resistance to impact caused during dispersing process because the first carbon black has not only a small average primary particle diameter but also is highly structured. When a bead having a size of more than 0.5 mm is used in the dispersing process, the structure of the first carbon black is broken by strong collision energy among bead particles, resulting in that the stability of the carbon black dispersion liquid thus obtained is impaired. Therefore, the diameter of the bead is preferably 0.5 mm or less. The diameter of the bead is more preferably 0.1 mm or less.

The block type copolymer having structural unit of the diene monomer and the aromatic vinyl monomer is used as the dispersant, wherein the block type copolymer has a sulfonic acid group or salt thereof. The dispersant is made by sulfonation of a base block copolymer having structural unit of the diene monomer and the aromatic vinyl monomer.

Examples of the diene monomer include an isoprene monomer. Examples of the aromatic vinyl monomer include a styrene monomer.

The base block copolymer, composed of the isoprene monomer and the styrene monomer, is made by copolymerization of the isoprene monomer and the styrene monomer at −100° C. to 150° C., preferably at 0° C. to 130° C., in the presence of an initiator of radical polymerization such as hydrogen peroxide, benzoyl peroxide, and azobisisobutyronitrile; or an anionic polymerization initiator such as n-butyllithium, sodiumnaphthalene, and metallic sodium; and optional publicly known solvent.

Examples of the block structure of the base block copolymer include AB type such as isoprene-styrene block copolymer, and ABA type such as styrene-isoprene-styrene terpolymer.

In the base copolymer, the mol ratio of the isoprene monomer and the styrene monomer is preferably in the range of 45/55 to 20/80, more preferably in the range of 40/60 to 30/70.

When the mol ratio of the isoprene monomer exceeds the range, i.e. amount of styrene monomer is low, the adsorption of the dispersant to the surface of the first carbon black becomes inadequate, and then the jetting stability and the preservation stability may decrease. Preferably, the base copolymer has high amount of the styrene monomer having high compatibility to the first carbon black so as to improving adsorptive property. The carbon black, having structure such that aromatic rings lay in a same plain as well as graphite, has pi electrons. The pi electrons of the carbon black interact with pi electrons of the styrene monomer of the dispersant. The block copolymer is preferable for improving adsorptive property between the first carbon black and the dispersant.

When the mol ratio of the base copolymer is less than the range, i.e., amount of the styrene monomer is high, the dispersibility of the first carbon black to water becomes inadequate, and then it becomes difficult to decrease the dispersion diameter of the first carbon black, and the preservation stability may decrease.

Preferably, the base copolymer has a weight-average molecular weight (Mw) in polystyrene equivalent of 1,000 to 500,000, more preferably 3,000 to 100,000, and even more preferably 5,000 to 20,000. When the Mw of the base copolymer is lower than 1,000, the dispersibility of the first carbon black may decrease. When the Mw of the base copolymer is higher than 500,000, the dispersiblity may decrease, or viscosity of the pigment dispersion liquid (A) may increase.

The dispersant can be obtained by sulfonation of the base copolymer using a known method as described in “Shinjikken Koza (New Institute of Experiment)”, The Chemical Society of Japan, Vol. 14-III, page 1,773 or Japanese Patent Laid-Open No. 02-227403, which is hereby incorporated by reference. The double bond of the isoprene monomer in the base copolymer is sulfonated by a sulfonating agent. During the sulfonation, the hydrogen atom is substituted by the sulfonic acid while the double bond undergoes ring opening to form a single bond or is left closed. In the case, the double bond moiety may be sulfonated not only in the isoprene unit portion but also in the styrene unit portion. As the sulfonating agent to be used herein there is preferably used sulfuric anhydride, a complex of sulfuric anhydride with an electron-donating compound, sulfuric acid, chlorosulfonic acid, fuming sulfuric acid, hydrogensulfite (Na salt, K salt, Li salt, etc.) or the like.

Examples of the electron-donating compound include ethers such as N,N-dimethylformamide, dioxane, dibutyl ether, tetrahydrofurane and diethylether; amines such as pyridine, piperazine, trimethylamine, triethylamine and tributylamine; sulfides such as dimethyl sulfide and diethyl sulfide; and nitrile compounds such as acetonitrile, ethylnitrile and propylnitrile. Preferred among these electron-donating compounds are N,N-dimethylformamide and dioxane.

The amount of the sulfonating agent, in sulfuric anhydride equivalent, is normally from 0.005 mols to 1.5 mols, preferably from 0.01 mols to 1.0 mol per 1 mol of the total amount of the isoprene monomer unit and styrene monomer unit in the base copolymer. When the amount of the sulfonating agent is less than 0.005 mols, the product material with desired property may not be obtained because the rate of the sulfonation is insufficient. When the amount of the sulfonating agent is more than 1.5 mols, a large amount of sulfuric anhydride is left unreacted, and even if neutralized with an alkali, a large amount of sulfate are produced that lowers purity.

During the sulfonation, the solvent which is inactive to the sulfonating agent may be used. Examples of the solvent include halogenated hydrocarbons such as chloroform, dichloroethane, tetrachloroethane, tetrachloroethylene, and dichloromethane; nitro compounds such as nitromethane and nitrobenzene; liquid sulfur dioxide; aliphatic hydrocarbons such as propane, butane, pentane, hexane, and cyclohexane; and ether type solvents such as dioxane and tetrahydrofuran. These solvents may be used in combination of two or more thereof.

The reaction temperature of the sulfonation is normally −70° C. to 200° C., preferably −30° C. to 50° C. All intermediate values and subranges are contemplated. When the reaction temperature is less than −70° C., it may not be economical because reaction speed of the sulfonation becomes slow. When the reaction temperature is more than 200° C., reaction product turns black or insolubilized due to side reaction.

The salt of the sulfonated base copolymer is made by reaction of the sulfonated base copolymer and a basic compound.

Examples of the basic compound include alkaline metal hydroxides such as sodium hydroxide, potassium hydroxide and lithium hydroxide; alkaline metal alkoxides such as sodium methoxide, sodium ethoxide, potassium methoxide, sodium t-butoxide, and potassium t-butoxide; carbonates such as sodium carbonate, potassium carbonate, and lithium carbonate; organic metal compounds such as methyl lithium, ethyl lithium, n-butyl lithium, sec-butyl lithium, amyl lithium, propyl sodium, methylmagnesium chloride, ethyl magnesium bromide, propyl magnesium iodide, diethyl magnesium, diethyl zinc, triethylaluminum, and triisobutyl aluminum; amines such as aqueous ammonia, trimethylamine, triethylamine, tripropylamine, tributylamine, pyridine, aniline, dimethyl ethanolamine, diethanolamine, triethanolamine, monoethanolamine, aminomethylpropanol, and piperazine; and metal compounds such as sodium, lithium, potassium, calcium, and zinc.

These basic compounds may be used singly or in combination of two or more thereof. Among these basic compounds, the alkaline metal hydroxide, and the amine are preferable, wherein the sodium hydroxide and the lithium hydroxide are more preferable.

The amount use of the basic compound is not more than 2 mols, preferably not more than 1.3 mols, per 1 mol of the sulfonating agent.

During the reaction, the basic compound can be used as an aqueous solution, or can be dissolved in an organic solvent that is inactive to the basic compound.

Examples of the organic solvent are not only the aforementioned organic solvent used for the sulfonation but also aromatic hydrocarbon compounds such as benzene, toluene, and xylene; and alcohols such as methanol, ethanol, propanol, isopropanol, and ethylene glycol.

These organic solvents may be used singly or in combination of two or more thereof.

When the basic compound is used as the aqueous solution or the organic solution, the concentration of the basic compound is normally 1% to 70% by mass, preferably 10% to 50% by mass.

The reaction temperature of the sulfonated base copolymer and the basic compound is normally −30° C. to 150° C., preferably 0° C. to 120° C., more preferably 50° C. to 100° C. The reaction may take place under ordinary pressure, reduced pressure, or increased pressure.

The reaction time of the sulfonated base copolymer and the basic compound is normally 0.1 hours to 24 hours, preferably 0.5 hours to 5 hours.

The amount of the sulfonic acid group or salt thereof in the sulfonated base copolymer synthesized as described above is 0.1 mmol/g to 2.5 mmol/g, preferably 0.2 mmol/g to 2 mmol/g, and more preferably 0.5 mmol/g to 1 mmol/g. When the amount is less than 0.1 mmol/g, the dispersibility of the pigment may decrease. When the amount is more than 2.5 mmol/g, the image density in printing on the plain paper may decrease.

The structure of the sulfonated base copolymer or salt thereof is identifiable by absorption of the sulfonic acid group in an infrared absorption spectrum. The structure is also identifiable by a nuclear magnetic resonance spectrum. The composition ratio of the sulfonated base copolymer is confirmable by elemental analysis.

The sulfonated base copolymer or salt thereof, synthesized as described above, is preferably used as emulsified in water.

The emulsion is made by mixing the organic solution of the sulfonated base copolymer with water or the basic compound to emulsify, and then removing the organic solvent with leaving water.

The emulsification is accomplished by general methods such as mixing the organic solution of the sulfonated base copolymer or salt thereof with adding water into the solution; adding the organic solution of the sulfonated base copolymer or salt thereof into water with mixing the solution; and adding water and the organic solution of the sulfonated base copolymer simultaneously and mixing them. However, the method of the emulsification is not limited to aforementioned examples.

Examples of the organic solvent used for the emulsification include aromatic series solvents such as toluene and xylene; aliphatic series solvents such as hexane and heptane; ketone series solvents such as tetrahydrofuran and dioxane; ether series solvents such as dioxane and tetrahydrofurane; and ester series solvents such as ethyl acetate and butyl acetate; and alcohol series solvents such as methanol, ethanol, and isopropyl alcohol. Two or more of these solvents may be properly used in combination.

The amount of the organic solvent used for the emulsification is preferably 20 parts to 5,000 parts by mass, more preferably 50 parts to 2,000 parts by mass, per 100 parts by mass of the sulfonated base copolymer or salt thereof. When the amount of the organic solvent is less than 20 parts by mass, stable emulsion may not be obtained. When the amount of the organic solvent is more than 5,000 parts by mass, productivity may decrease.

The amount of water used for the emulsification is preferably 50 parts to 10,000 parts by mass, more preferably 100 parts to 5,000 parts by mass, for 100 parts by mass of the sulfonated base copolymer or salt thereof. When the amount of water is less than 50 parts by mass, stable emulsion may not be obtained. When the amount of water is more than 10,000 parts by mass, the productivity may decrease.

The emulsification may also be accomplished in the presence of a surfactant. Examples of the surfactant include nonionic surfactants such as polyoxyethylene alkyl ether, polyoxysorbitane ester and polyoxyethylene alkylamine ether; anionic surfactants such as oleate, laurate, rosinate, dodecylbenzenesulfonate, and polyoxyethylene alkylether sulfuric acid ester; and cationic surfactants such as octyltrimethylammonium bromide, dioctyldimethyl ammonium chloride and dodecylpyridinium chloride.

These surfactants may be used singly or in combination of two or more thereof.

The aforementioned surfactant may be used in the form of solution or dispersion in the aforementioned organic solvent solution of the sulfonated base copolymer or salt thereof, or water.

The amount of the surfactant is preferably not more than 10 parts by mass, more preferably 5 parts by mass, per 100 parts by mass of the sulfonated base copolymer or salt thereof. When the amount is more than 10 parts by mass, purity of the emulsion containing the sulfonated base copolymer or salt thereof may decrease.

For adjusting pH of system, an alkali compound such as sodium hydroxide, or lithium hydroxide; or an inorganic acid such as hydrochloric acid or sulfuric acid, may be used. Preferably, the pH of the system is 5 to 12.

In the pigment dispersion liquid A, the amount of the dispersant is preferably 0.005 parts to 1 part by mass, more preferably 0.01 parts to 0.5 parts by mass, for 1 part by mass of the pigment. When the amount of the dispersant is not less than 0.005 parts by mass, the preservation stability of the pigment dispersion liquid A and the inkjet recording ink may be ensured, and generation of nozzle clogging tends to be decreased. When the amount of the dispersant is not more than 1 part by mass, the viscosity of the pigment dispersion liquid A and the inkjet recording ink does not become too high, and printing by the inkjet recording method does not become difficult.

By using the dispersant, the volume average particle diameter (D50) of the pigment in the pigment dispersion liquid A may become 70 nm to 180 nm, and standard deviation of the particle diameter, derived from particle size distribution of the pigment, may become not more than ½ of the aforementioned D50. By using the pigment dispersion liquid A, the inkjet recording ink provides images having high image density, and the inkjet recording ink has enough preservation stability and jetting stability. The volume average particle diameter of the pigment may be measured by a particle distribution measuring apparatus, manufactured by NIKKISO CO., LTD. at 23° C. and 55% RH.

The concentration of the pigment in the pigment dispersion liquid A is preferably 5% to 25% by mass, more preferably 10% to 20% by mass per all amount of the pigment dispersion liquid A. When the concentration of the pigment is not less than 5% by mass, the productivity does not decrease. When the concentration of the pigment is not more than 25% by mass, the pigment is dispersible because the viscosity of the pigment dispersion liquid A does not become too high.

The pigment dispersion liquid A may include not only the first carbon black, the dispersant, and water but also additives such as water-soluble organic solvent, non-ionic surfactant, anionic surfactant, cationic surfactant, ampholytic surfactant, and antiseptic agent.

The examples of the water-soluble organic solvent include alcohols such as methanol, ethanol, 1-propanol, and 2-propanol; multiple alcohols such as ethylene glycol, diethylene glycol, triethylene glycol, propylene glycol, and glycerin; pyrrolidone derivatives such as N-methylpyrrolidone and 2-pyrrolidone; ketones such as acetone and methyl ethly ketone; and alkanolamines such as monoethanolamine, diethanolamine, and triethanolamine. The water-soluble organic solvent is not limited to the aforementioned examples but may be selected depending on the purpose.

The pigment dispersion liquid A is made by wet dispersion treatment of the pigment, the dispersant, water, and the optional additive, using publicly known disperser such as a sand mill, a ball mill, a roll mill, a bead mill, a nanomizer, and a homogenizer.

The wet dispersion treatment means a treatment in accordance with so-called wet dispersion method, wherein a mixture of the pigment, the dispersant, water, and the optional water-soluble organic solvent is finely grinded by the disperser to disperse.

The pigment dispersion liquid A is preferably used for the pigment type inkjet recording ink.

### <Pigment Dispersion Liquid B>

The second carbon black used for the pigment dispersion liquid B is dispersible in water without the dispersant by surface treatment to bind a carboxyl group or salt thereof. The amount of the carboxyl group on the surface of the second carbon black particle is adjusted to 2.0 μmol/m² to 5.0 μmol/m².

The surface treatment is accomplished in such a way as an oxidation treatment by oxidant or ozone; a physical treatment such as vacuum plasma; binding the carboxyl group to the surface of the carbon black chemically using diazoalkyl compound of M. L. Studebaker, N═N—R—X; binding phenol compound to the surface of the carbon black by radical reaction; and grafting molecule containing carboxyl group to the surface of the carbon black.

When the oxidation treatment is provided to the carbon black, various functional groups such as carboxyl group (—COOH), hydroxyl group (—OH), and quinone group (>C═O) are produced on the surface of the carbon black depending on oxidation condition. Among them, the carboxyl group and the hydroxyl group are hydrophilic and acidic functional group having active hydrogen. Therefore, the total amount of the carboxyl group and the hydroxyl group is related to formation of stable dispersion state. However, the carboxyl group dominates the dispersibility, because the dissociation constant of the hydroxyl group is 8 to 10, which is much higher than the dissociation constant of the carboxyl group, 2 to 5. The quinone group may become an obstructive factor for the dispersibility, because the quinone group has low affinity for water. Thus, when the amount of the carboxyl group on the surface of the carbon black becomes higher, the dispersibility of the carbon black also becomes higher.

When hydrophilic property of the carbon black becomes higher, the permeability of the carbon black into fibers of the paper also becomes higher, that brings low image density of black color in printing. The amount of hydrophilic functional group, located on contact interface between the carbon black and the water, has an important function in dispersing the carbon black into water or in the dispersed state. Thus, the dispersibility cannot be evaluated by the amount of the functional group per unit mass.

Therefore, the value, that the amount of the carboxyl group is divided by the nitrogen adsorption specific surface area of the carbon black, is adjusted to 2.0 μmol/m² to 5.0 μmol/m².

The amount of the carboxyl group may be measured in the manner described below.

2 g to 5 g of the carbon black are added into 0.5 L of 0.976 mol/L sodium hydrogen carbonate aqueous solution, and then the solution is shaken for 6 hours to obtain reaction solution. The carbon black is divided by filtration from the reaction solution. 0.05 mol/L of hydrochloric acid aqueous solution are added to filtrate. Then, quantity of the carboxyl group is determined by neutralization titration using 0.05 mol/L of sodium hydroxide until pH becomes 7.0. This measured valued is divided by BET specific surface area (m²/g) of the carbon black to obtain the amount of the carbon black (μmol/m²). The BET specific surface area is measured in reference to JIS K6217, “Testing methods of fundamental characteristics of carbon black” which is incorporated by reference.

For the oxidation treatment, wet oxidation is used preferably. Examples of the oxidant for the oxidation treatment include peroxodiacid, peroxodiacid salt, perboric acid, percarbonic acid, and superphosphoric acid. Examples of the acid for the oxidant preferably include sulfuric acid, boric acid, carbonic acid, and phosphoric acid. Examples of the salt for the oxidant preferably include alkali metals such as sodium, potassium, and lithium; and ammonium salt.

The oxidation treatment is provided by adding the carbon black into aqueous solution of the oxidant, and mixing them. The concentration of the aqueous solution, the amount of the carbon black, reaction temperature, and reaction time are arbitrarily adjusted respectively.

Reduced salt is separated from the carbon black, which the oxidation treatment is provided, by ion-exchange resin, electrodialysis, or separating films such as reverse osmosis membrane, ultrafiltration membrane, or loose R.O, and then, neutralization treatment is provided.

Examples of the neutralizer preferably include aqueous solution of inorganic alkalies such as alkali metal hydroxide, hydrogen carbonate, and acetate; or aqueous solution of organic alkalies such as quaternary amine hydroxide. Among them, the alkali metal hydroxide is preferably used, because high image density is obtained in printing on the plain paper.

The degree of the neutralization, i.e. pH, is preferably 4.0 to 9.0 for preventing gelatification, more preferably 6.0 to 8.0 for obtaining high image density in printing on the plain paper, and for obtaining high preservation stability of the inkjet ink.

The carbon black as a raw material has the particle size distribution. Therefore, the carbon black, which the oxidation treatment is provided, also has particle size distribution. Thus, the carbon black includes particles having low water dispersibility due to inadequate oxidation, or particles that tend to settle down due to large particle size. Therefore, particles that oxidation treatment is inadequate or having large particle size may be removed. In this case, classification treatment using centrifugation or function membrane may be used. Thus, the carbon black is reformed to have sharp particle size distribution, to be adequately oxidized, and to have high water dipersibility.

When the concentration of the carbon black dispersed in water is more than 50% by mass, the carbon black tends to reaggregate in the dispersion, and then it becomes difficult to maintain stable dispersibility over a long period.

The pigment dispersion liquid B has an electron conductivity of 0.6 mS/cm to 1.8 mS/cm, when the concentration of the second carbon black dispersed is adjusted to 20% by mass.

The pigment dispersion liquid B is promptly desalted and purified, because when the pigment dispersion liquid B includes unneutralized salts, the carbon black tends to clump together. The function membrane such as the ultrafiltration membrane, reverse osmosis membrane, or the electrodialytic membrane is used for desalting and purification. In addition, the electric conductivity is adjusted to not more than 1.8 mS/cm to maintain stable dispersibility over a long period. When the electric conductivity is more than 1.8 mS/cm, the salts such as humate are eluted from the carbon black during long-term preservation, which brings aggregation of the carbon black, increasing of viscosity, or decreasing of the dispersion stability or the preservation stability. When the electric conductivity is less than 0.6 mS/cm, the image density may decrease in printing on the plain paper. The electric conductivity is measured in reference to JIS K 0130. For example, electric conductivity may be measured by electric conductivity measuring machine, CM-20R manufactured by DKK-TOA CORPORATION at 25° C.; which is incorporated by reference.

The carbon black used as a raw material of the pigment dispersion liquid B is not particularly limited and can be appropriately selected depending on the purpose. Examples thereof include carbon blacks manufactured by known methods such as contact method, furnace method, and thermal method.

The type of the carbon black is not particularly limited and can be appropriately selected depending on the purpose. Examples thereof include acid carbon black, neutral carbon black, and alkaline carbon black. Examples of the carbon black include furnace black, lamp black, acetylene black, and channel black.

The carbon black may be prepared by synthesis or commercially available products.

Examples of the commercially available product include #10B, #20B, #30, #33, #40, #44, #45, #45L, #50, #55, #95, #260, #900, #1000, #2200B, #2300, #2350, #2400B, #2650, #2700, #4000B, CF9, MA8, MA11, MA77, MA100, MA220, MA230, MA600, and MCF88, manufactured by Mitsubishi Chemical Corporation; MONARCH 120, MONARCH 700, MONARCH 800, MONARCH 880, MONARCH 1000, MONARCH 1100, MONARCH 1300, MONARCH 1400, MOGUL L, REGAL 99R, REGAL 250R, REGAL 300R, REGAL 330R, REGAL 400R, REGAL 500R, and REGAL 660R, manufactured by Cabot Corporation; PRINTEX A, PRINTEX G, PRINTEX U, PRINTEX V, PRINTEX 55, PRINTEX 140U, PRINTEX 140V, SPECIAL BLACK 4, SPECIAL BLACK 4A, SPECIAL BLACK 5, SPECIAL BLACK 6, SPECIAL BLACK 100, SPECIAL BLACK 250, COLOUR BLACK FW1, COLOUR BLACK FW2, COLOUR BLACK FW2V, COLOUR BLACK FW18, COLOUR BLACK FW200, COLOUR BLACK S150, COLOUR BLACK S160, and COLOUR BLACK S170, manufactured by Degussa Japan Co., Ltd.; SEAST 9H, manufactured by TOKAI CARBON CO., LTD. Such commercially available products include those described in the most recent versions of the manufacturer or supplier catalogs or product literature which are incorporated by reference.

In the inkjet recording ink, the ratio of the amount between the first carbon black derived from the pigment dispersion liquid A and the second carbon black having carboxyl group derived from the pigment dispersion liquid B is preferably 90:10 to 50:50 by mass, more preferably 85:15 to 60:40 by mass.

When the ratio of the first carbon black is more than 90% by mass, the image density may decrease in printing on the plain paper. When the ratio of the first carbon black is less than 50% by mass, the image density may decrease in printing on the gloss paper. When the ratio of the second carbon black, which is self-dispersion type carbon black, becomes higher, the image density also becomes higher in printing on the plain paper, because the pigment tends to clumps together as soon as the inkjet recording ink attached on the paper, and then aggregates having large particle size are generated at near-surface of the paper. Meanwhile, aggregates are difficult to penetrate into the surface of the gloss paper, because the diameter of fine pores at the surface of the gloss paper is small. Therefore, rough surface is formed at attachment site of the inkjet recording ink in printing on the gloss paper, and then the image density may decrease.

The volume average particle diameter (D50) of the carbon black in the inkjet recording ink, measured by dynamic light scattering method, is preferably 70 nm to 180 nm. The standard deviation of the particle diameter obtained from size distribution of the carbon black is preferably not more than one-half of the volume average particle diameter (D50). Herewith, the inkjet recording ink provides enough image density, jetting stability, and preservation stability. The volume average particle diameter of the carbon black is measured by the particle size distribution measuring apparatus, UPA-EX150 manufactured by NIKKISO CO., LTD. at of 23° C., 55% RH.

The amount of the carbon black in the inkjet recording ink is preferably 1% to 20% by mass, more preferably 3% to 15% by mass. When the amount is not more than 1% by mass, the inkjet recording ink may not provide sharp image due to low image density. When the amount is not less than 20% by mass, the viscosity of the inkjet recording ink tends to increase and then nozzle clogging tends to take place.

The inkjet recording ink may include a wetting agent, a penetrating agent, a surfactant, and other additives.

The other additives include deforming agent, antiseptic agent, antifungal agent, antirust, pH adjuster, specific resistance adjuster, antioxidant, ultraviolet absorber, oxygen absorber, light stabilizer, and viscosity modifier.

### —Wetting Agent—

The wetting agent is used to ensure water-retention and wetability of the inkjet recording ink. Herewith, excellent preservation stability of the inkjet recording ink is achieved, wherein the pigment of the inkjet recording will not clumping together, and viscosity will not increase in storing long period. In addition, the inkjet recording ink keeps flowability over a long period, even when the inkjet recording ink is dried. Moreover, it is possible to obtain high ejection stability without substantially causing nozzle clogging during recording or during rebooting process of the printer after recording discontinuation.

The boiling point of the wetting agent is preferably not less than 180° C.

The wetting agent is not particularly limited and can be appropriately selected depending on the purpose. Examples thereof include multiple alcohols such as ethylene glycol, diethylene glycol, 1-3-butyl glycol, triethylene glycol, polyethylene glycol, polypropylene glycol, 1,5-pentanediol, 1,6-hexanediol, glycerin, 1,2,6-hexanetriol, 2-ethyl-1,3-hexanediol, ethyl-1,2,4-butanetriol, 1,2,3-butanetriol, and petriol; multiple alcohol alkyl ethers such as ethyleneglycolmonoethylether, ethyleneglycolmonobutylether, diethyleneglycolmonomethylether, diethyleneglycolmonoethylether, diethyleneglycolmonobuthylether, tetraethyleneglycolmonomethylether, and propyleneglycolmonoethylether; multiple alcohol aryl ethers such as ethyleneglycolmonophenylether, and ethyleneglycolmonobenzilether; nitrogen-containing heterocyclic compounds such as 2-pyrolidone, N-methyl-2-pyrolidone, N-hydroxyethyl-2-pyrolidone, 1,3-dimethylimidazolidinone, ε-caprolactam, and γ-butyrolactone; amides such as formamide, N-methylformamide, and N,N-dimethylformamide; amines such as monoethanolamine, diethanolamine, triethanolamine, monoethylamine, diethylamine, and triethylamine; sulfur-containing compounds such as dimethysulfoxide, sulfolane, and thio-diethanol; propylene carbonate, and ethylene carbonate.

These wetting agents may be used alone or in combination of two or more. Among these wetting agents, 1,3-butylglycol, diethyleneglycol, triethyleneglycol, and glycerin are particularly preferred in terms of preventing clogging due to ink drying, i.e. defects in injection property due to water evaporation, and providing excellent effects in improving color saturation of images.

The ratio of the amount of the wetting agent against the total amount of the inkjet recording ink is preferably not more than 50% by mass, and more preferably 5% by mass to 40% by mass.

### —Penetrating Agent—

The penetrating agent is not particularly limited and can be appropriately selected depending on the purpose. Examples thereof include nonionic surfactants such as polyoxyethylene alkyl ethers, polyoxyethylene alkyl phenyl ethers, polyoxyethylene glycol esters, polyoxyethylene polyoxypropylene decyl ethers, acetylene surfactants, silicone surfactants, and fluorine surfactants.

### —Surfactant—

In the inkjet recording ink according to the present embodiment, the surfactant may be added at such an amount that it does not affect its inkjet recording ink properties. Examples of the surfactant include nonionic surfactants, anionic surfactants, cationic surfactants, and ampholytic surfactants. Specific examples of the nonionic surfactants include those of BT Series, manufactured by Nikko Chemicals Co., Ltd.; those of NONIPOL Series, manufactured by Sanyo Chemical Industries, Ltd.; those of D-Series and O-Series, manufactured by Takemoto Oil & Fat Co., Ltd.; those of SURFINOL Series, manufactured by Air Products & Chemicals Inc.; those of OLFIN Series, manufactured by Nisshin Chemicals Co., Ltd.; those of EMALEX DAPE Series, manufactured by NIHON EMULSION Co., Ltd.; silicone surfactants, manufactured by DOW CORNING TORAY SILICONE CO., LTD.; and fluorine surfactants, manufactured by Neos Co., Sumitomo 3M Ltd., E.I. du Pont de Nemours and Company, and Daikin Industries, Ltd., respectively.

The inkjet recording ink according to this embodiment may be prepared by publicly known method. For example, the aforementioned pigment dispersion liquids, the wetting agent, the penetrating agent, and the surfactant are mixed. Subsequently, coarse particles and foreign substances such as dust and trash are removed by metallic filter or membrane filter, and optional deaeration.

Suitable recording medium for the inkjet recording ink according to this embodiment is not particularly limited and can be appropriately selected depending on the purpose. Examples thereof include the plain paper and the gloss paper; each of them may be ink-absorbable material or ink-unabsorbable material.

Examples of the recording medium include sheets of plastics having base material such as polyethylene terephthalate, polycarbonate, polypropylene, polyethylene, polysulfone, ABS resins, and polyvinyl chloride resins; metal coated sheets in which a metal layer is formed on a non-metal material or metal material such as brass, iron, aluminum, stainless steel and copper using a method such as vapor deposition; papers subjected to water-repellent treatment; ceramics which are prepared by sintering inorganic materials at a high temperature. Among these materials, papers are more preferable because the cost is relatively low and the images formed thereon look natural.

### <Ink Cartridge>

The ink cartridge according to this embodiment includes a container containing the aforementioned inkjet recording ink of this embodiment therein, and further includes other appropriated selected members as required.

The container is not particularly limited and its shape, structure, size, and material are appropriately selected according to the purpose. Preferred embodiments include those at least having an ink pouch formed by aluminum laminated film or resin film.

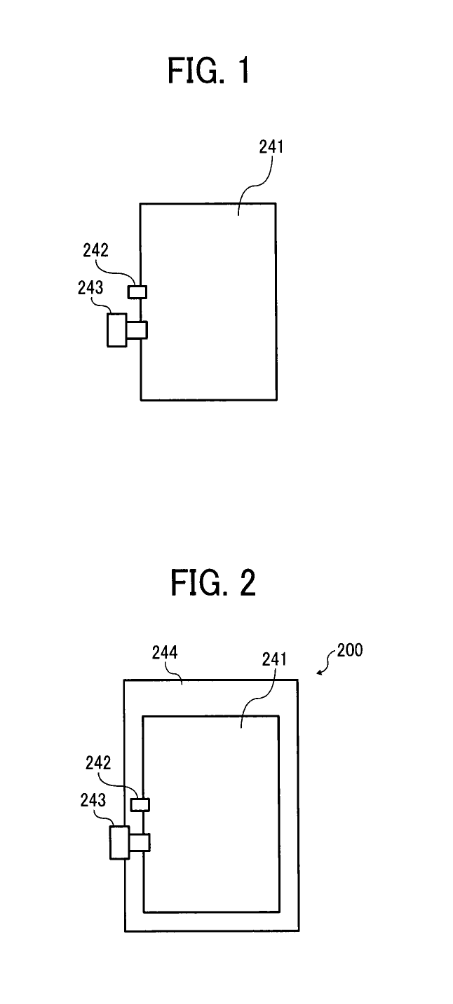

The ink cartridge is hereinafter described with reference to FIGS. 1 and 2. FIG. 1 is an illustration showing an embodiment of the ink cartridge of the present invention. FIG. 2 is an illustration of the ink cartridge of FIG. 1 including a casing, i.e. exterior.

In an ink cartridge 200, as shown in FIG. 1, an ink pouch 241 is filled through an ink inlet 242. The ink inlet 242 is closed by fusion bonding after the air is exhausted. An ink outlet 243 made of a rubber material is pierced by a needle on the apparatus body for use, thereby the ink is supplied to the apparatus. The ink pouch 241 is formed by a packaging member such as a non-permeable aluminum laminated film. The ink pouch 241 is housed in a cartridge case 244 generally made of plastics as shown in FIG. 2 and detachably mounted on various types of inkjet recording apparatus.

The ink cartridge 200 can be detachably mounted on variety types of inkjet recording apparatus and it is particularly preferable that the ink cartridge 200 is detachably mounted on the inkjet recording apparatus of the embodiment described below.

### <Inkjet Recording Apparatus>

The inkjet recording ink of the embodiment is applicable to various recording in an inkjet recording system such as inkjet recording printers, facsimiles, copy machines, and printer/fax/copy complex machines.

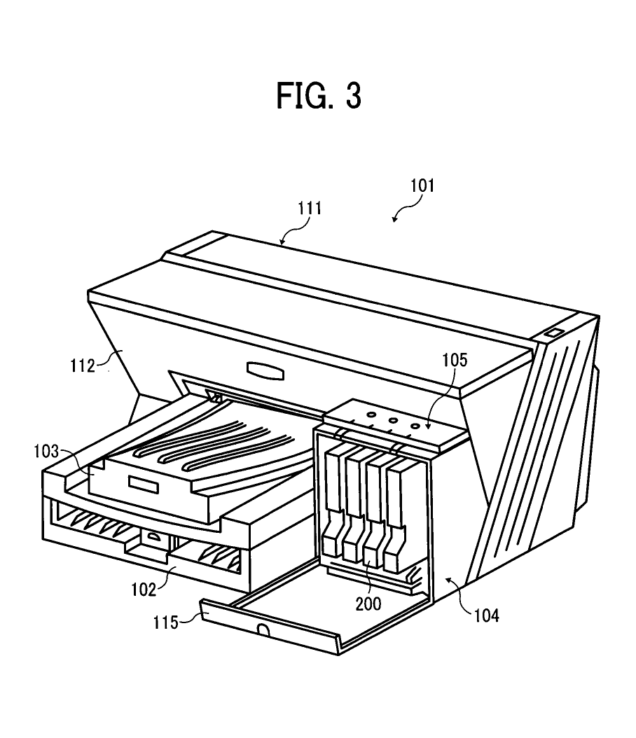

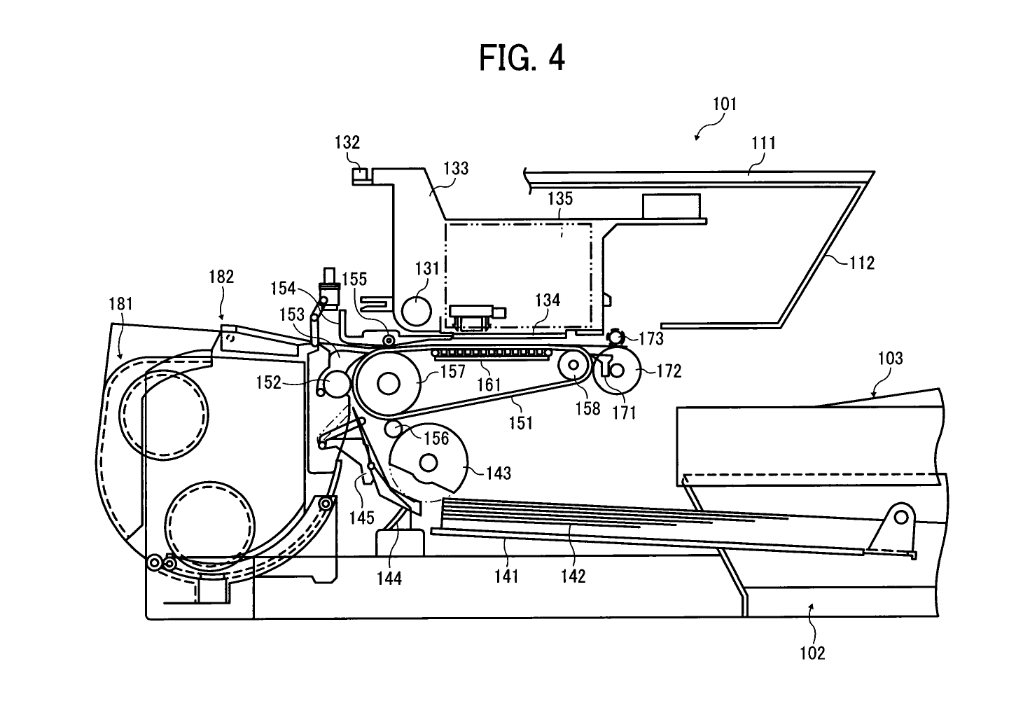

An embodiment of the inkjet recording apparatus of the present invention is described hereinafter, with reference to FIGS. 3 and 4.

An inkjet recording apparatus shown in FIG. 3 includes an apparatus body 101, a feeder tray 102 attached to the apparatus body 101 for feeding papers, a paper output tray 103 attached to the apparatus body 101 for receiving papers on which images are recorded or formed, and an ink cartridge mounting part 104. An operation part 105 having operation keys and indicators is provided on the top surface of the ink cartridge mounting part 104. The ink cartridge mounting part 104 has front cover 115 that can be opened or closed to remove or place ink cartridges 200. In addition, the apparatus body 101 has an upside cover 111 and a forehead of the front cover 112.

As shown in FIG. 4, a carriage 133 is supported slidably in the scan direction by guide rod 131 that is a guide member laid across right and left side plates and stay 132 and moved by a main motor in the arrowed directions for scanning within the apparatus body 101.

Recording heads 134 including four inkjet recording heads that eject yellow (Y), cyan (C), magenta (M), and black (Bk) recording ink droplets, respectively, have ink ejection ports arranged in the intersecting direction with the main scanning direction and they are placed in the carriage 133 with their ink ejection direction downward.

Inkjet recording heads constituting the recording heads 134 are provided with an energy generation unit for ejection the ink such as a piezoelectric actuator such as an piezoelectric element, a thermal actuator using an electrothermal conversion element such as an exothermic resistor to cause film boiling and, accordingly, phase change of a liquid, a shape-memory alloy actuator using metal phase changes due to temperature changes, and an electrostatic actuator using electrostatic force.

The carriage 133 is provided with subtanks 135 for supplying each color ink to the recording heads 134. The subtanks 135 are filled with the ink of the embodiment from the ink cartridge 200 mounted in the ink cartridge mounting part 105 via a ink supply tube.

A paper feed part for feeding paper 142 stuck on paper load part 141, i.e. platen, of the feed tray 102 includes a half-moon roller, i.e. feed roller 143, that separates and supplies the paper 142 from the paper load part 141 one by one and separation pad 144 that faces the feed roller 143 and is made of a large friction coefficient material. The separation pad 144 is biased toward the feed roller 143.

A conveying part for conveying the paper 142 supplied from the feed part underneath the recording heads 134 includes a conveying belt 151 for electrostatically adsorbing and conveying the paper 142, counter roller 152 for conveying the paper 142 sent from the paper feed part via guide 145 by clamping it together with the conveying belts 151, conveying guide 153 for turning the paper 142 sent nearly vertically by 90° so as to lay it on the conveying belt 151, and leading end pressure roller 155 that is biased toward the conveying belt 151 by presser member 154. Charging roller 156 that is a charging unit for charging the surface of the conveying belt 151 is also provided.

The conveying belt 151 is an endless belt, being placed over conveying roller 157 and a tension roller 158 and running around in the belt conveying direction. For example, the conveying belt 151 has a front layer that is a paper adsorbing surface made of a dragging-uncontrolled resin, for example a copolymer of tetrafluoroethylene and ethylene (ETFE), having a thickness of 40 μm, and a back layer, i.e. an intermediate dragging layer or an earth layer, made of the same material as the front layer, but dragging-controlled with carbon. Guide member 161 is provided behind the conveying belt 151 at the corresponding position to the printing area by the recording heads 134. An output part for discharging the paper 142 on which recording is done by the recording heads 134 includes separation click 171 for separating the paper 142 from the conveying belt 151, paper output roller 172, and paper output roller 173. Paper output tray 103 is disposed below paper output roller 172.

Double-side feeding unit 181 is detachably mounted in the back of the apparatus body 101. The double-side feed unit 181 takes in the paper 142 that is moved backward as the conveying belt 151 is rotated in the reverse direction, turns it over, and feeds it again between the counter roller 152 and the conveying belt 151. Manual feeder 182 is provided on the top surface of the double-side feed unit 181.

In this inkjet recording apparatus, the paper 142 is separated and fed from the paper feed part one by one. Being fed vertically, the paper 142 is guided by the guide 145 and conveyed between the conveying belt 151 and the counter roller 152. Then, it is guided by the conveying guide 153 at the leading end and is pressed against the conveying belt 151 by the leading end pressure roller 155 to change the convey direction substantially by 90°.

Meanwhile, the conveying belt 151 is charged by the charging roller 156, and the paper 142 is electrostatically adsorbed and conveyed by the conveying belt 151. Then, the recording heads 134 are driven according to image signals while the carriage 133 is moved. Ink droplets are ejected on the paused paper 142 for recording one-line. Then, the paper 142 is conveyed by a certain rate for recording the next line. Receiving a recording end signal or a signal indicating the rear end of the paper 142 has reached the recording area, the recording operation is terminated and the paper 142 is ejected to the paper output tray 103.

When it is detected that the remaining amount of the recording ink in the subtank 135 is nearly to the end, a certain amount of recording ink is supplied to the subtank 135 from the ink cartridge 200.

In this inkjet recording apparatus, when the recording ink in the ink cartridge 200 of the present invention is used up, the case of the ink cartridge 200 is disassembled and only the ink pouch contained therein can be exchanged. The ink cartridge 200 allows for stable recording ink supply even in a vertical and front mounting structure. Therefore, when the apparatus body 101 is installed with the top being blocked by something, for example, the ink cartridge 200 can be housed in a rack. Even if something is placed on the top surface of the apparatus body 101, the ink cartridge 200 can be easily replaced.

Here, the explanation is made with reference to an application in a serial type, i.e. shuttle type, and inkjet recording apparatus in which the carriage scans is described. A line type inkjet recording apparatus having a line head is also applicable.

Specific non-limited embodiments of the invention include:

1. An inkjet recording ink comprising:

water; a dispersant containing a block type copolymer having structural unit of a diene monomer and an aromatic vinyl monomer, wherein the block type copolymer has a sulfonic acid group or salt thereof; a first carbon black; and a second carbon black having 2.0 μmol/m² to 5.0 μmol/m² of a carboxyl group on a surface thereof.

2. The inkjet recording ink according to embodiment 1, comprising a first pigment dispersion liquid containing water, the dispersant and the first carbon black, and a second pigment dispersion liquid containing water and the second carbon black, wherein the second pigment dispersion liquid has an electron conductivity of 0.6 mS/cm to 1.8 mS/cm.

3. The inkjet recording ink of embodiment 1, wherein the average primary particle diameter of the first carbon black ranges from 10.0 nm to 30.0 nm and the BET specific surface area of the first carbon black ranges from 100 m²/g to 400 m²/g.

4. The inkjet recording ink of embodiment 1, wherein the dispersant is a sulfonated block polymer or salt thereof having a mol ratio of isoprene monomer to styrene monomer ranging from 45/55 to 20/80.

5. The inkjet recording ink of embodiment 1, wherein the second carbon black has 3.5 μmol/m² to 4.8 μmol/m² of the carboxyl group on the surface thereof.

6. The inkjet recording ink of embodiment 1, the ratio of the first carbon black to the second carbon black is 85:15 to 60:40 by mass.

7. The inkjet recording ink made by a process comprising dispersing a first carbon black and a dispersant into water to obtain a first pigment dispersion liquid by wet dispersion treatment of the first carbon black, the dispersant, and water, and dispersing a second carbon black into water to obtain a second pigment dispersion liquid, wherein the second pigment dispersion liquid has an electron conductivity of 0.6 mS/cm to 1.8 mS/cm.

8. The inkjet recording ink of embodiment 7 which is made by a process further comprising mixing the first pigment dispersion liquid and the second pigment dispersion liquid.

9. A substrate comprising the inkjet recording ink of embodiment 1.

10. A substrate that is plain paper comprising the inkjet recording ink of embodiment 1.

11. A substrate that is glossy paper comprising the inkjet recording ink of embodiment 1.

12. A composition produced by drying or curing the inkjet recording ink of embodiment 1 or by drying or curing said inkjet recording ink on a substrate.

13. A printed substrate comprising the inkjet recording ink of embodiment 1 or an inkjet recording ink produced by drying or curing the inkjet recording ink of embodiment 1.

14. The printed substrate of embodiment 13 that is paper.

15. An ink cartridge or ink cartridge set comprising a container containing the inkjet recording ink as defined in embodiment 1.

16. An image forming device comprising the ink cartridge as defined in embodiment 15; and an ink ejector for ejecting the inkjet recording ink to form an image.

17. A method for forming an image on a substrate comprising applying the inkjet recording ink of embodiment 1 to a substrate using the image-forming device according to embodiment 16.

### EXAMPLES

The present invention will be more specifically explained with reference to Examples and Comparative Examples, but Examples shall not be construed to as limit the scope of the present invention in any way. Here, “part” and “%” in the examples are mass basis, respectively.

### <Polymer Used as the Dispersant>

Polymer A: DYNAFLOW PG3072D, manufactured by JSR Corporation, sulfonated substance of an isoprene/styrene block copolymer. The ratio between the isoprene and the styrene is 30:70 by mol. Isoprene unit is sulfonated.

### <Silicone Modified Acrylic Resin Used as a Fixing Agent>

### —Synthesis of Silicone Modified Acrylic Resin Fine-Particles not Containing Reactive Silyl Group—

First, the inside of a flask equipped with a mechanical stirrer, a thermometer, a nitrogen gas inlet tube, a flux tube and a dropping funnel is sufficiently purged with nitrogen gas. Then, log of Aqualon RN-20, manufactured by Dai-Ichi Kogyo Seiyaku Co., Ltd., 1 g of potassium persulfate and 286 g of purified water are introduced and heated to 65° C. Next, a mixed solution with 150 g of methyl methacrylate, 100 g of acrylic acid-2-ethylhexyl, 20 g of acrylic acid, 20 g of vinyltriethoxysilane, log of Aqualon RN-20, manufactured by Dai-Ichi Kogyo Seiyaku Co., Ltd., 4 g of potassium persulfate and 398.3 g of purified water is titrated into the flask over 2.5 hours. After maturing by heating at 80° C. for another 3 hours, the product is cooled down and the pH is adjusted to 7 to 8 with potassium hydroxide. In this case, the solid content concentration is adjusted to 30%.

### <Preparation of the Pigment Dispersion Liquid A>

### (Pigment Dispersion Liquid A-1)

| | |
|---|---|
| Carbon black, NIPES160-IQ, gas black having BET | 200 parts |
| specific surface area of 150 m²/g, manufactured by | |
| Degussa | |
| Polymer A, wherein the contents are adjusted to | 500 parts |
| 10% by adding water | |
| Purified water | 775 parts |

This aforementioned mixture is preliminarily dispersed by the ball mill using Zirconia bead. Then, the mixture is dispersed by disk-type (KDL batch-type) bead mill, manufactured by Shinmaru Enterprises Corporation, using 0.3 mm diameter Zirconia bead with rim speed of 10 m/s at liquid temperature of 10° C. for 5 minutes. Next, coarse particles are separated by centrifugation using centrifugal machine Model-7780, manufactured by KUBOTA Corporation, to obtain the pigment dispersion liquid A-1.

### (Pigment Dispersion Liquid A-2)

| | |
|---|---|
| Carbon black, NIPES160-IQ, gas black having BET | 200 parts |
| specific surface area of 150 m²/g, manufactured by | |
| Degussa | |
| Sodium naphthalenesulfonate formalin condensate, | 25 parts |
| PIONIN A-45-PN, manufactured by TAKEMOTO OIL & | |
| FAT Co., Ltd., contents of the active ingredient are 30% | |
| Purified water | 775 parts |

This aforementioned mixture is preliminarily dispersed by the ball mill using Zirconia bead. Then, the mixture is dispersed by disk-type (KDL batch-type) bead mill, manufactured by Shinmaru Enterprises Corporation, using 0.3 mm diameter Zirconia bead with rim speed of 10 m/s at liquid temperature of 10° C. for 5 minutes. Next, coarse particles are separated by centrifugation using centrifugal machine Model-7780, manufactured by KUBOTA Corporation, to obtain the pigment dispersion liquid A-2.

### <Preparation of the Pigment Dispersion Liquid B>

### (Pigment Dispersion Liquid B-1)

SHEAST 9H, manufactured by TOKAI CARBON CO., LTD. having BET specific surface area of 142 m²/g, is used for a raw material of the carbon black. 0.20 mmol/m² per unit surface area of the carbon black of sodium peroxodisulfate (Na₂S₂O₈) is weighed in accordance with formula 1 described below.

Necessary quantity of the sodium peroxodisulfate (mg)=Necessary mol quantity of the sodium peroxodisulfate per unit surface area of the carbon black (mmol/m²)×Specific surface of the carbon black (m²/g)×Quantity of the carbon black (g)×Equivalent amount of the sodium peroxodisulfate (238.1 g/mol) Formula 1:

The sodium peroxodisulfate is dissolved into 3 L of purified water, and then the carbon black is added to the sodium peroxodisulfate aqueous solution. The oxidation treatment is provided to the carbon black at reaction temperature of 60° C. and for reaction time of 10 hours.

The carbon black is separated by the filtration. The separated carbon black is dispersed in purified water, and then neutralized by the sodium hydroxide. After neutralization, slurry of the carbon black is centrifuged by centrifugal machine Model-7780, manufactured by KUBOTA Corporation, at rotating speed of 7,650 rpm, for 10 minutes.

Next, obtained supernatant solution is purified by ultrafiltration membrane, Biomax-50, manufactured by Millipore Corporation, having molecular weight cut off of 50,000, for 30 minutes. Then water is removed in such a way that the concentration of the carbon black dispersed is adjusted to 20%. Herewith, the pigment dispersion liquid B-1 is obtained.

### (Pigment Dispersion Liquid B-2)

The pigment dispersion liquid B-2 is obtained in the same manner as in the pigment dispersion liquid B-1, provided that the amount of the peroxodisulfate is changed to 0.05 mmol/m² per unit surface area of the carbon black.

### (Pigment Dispersion Liquid B-3)

The pigment dispersion liquid B-3 is obtained in the same manner as in the pigment dispersion liquid B-1, provided that the amount of the peroxodisulfate is changed to 0.09 mmol/m² per unit surface area of the carbon black.

### (Pigment Dispersion Liquid B-4)

The pigment dispersion liquid B-4 is obtained in the same manner as in the pigment dispersion liquid B-1, provided that the amount of the peroxodisulfate is changed to 0.30 mmol/m² per unit surface area of the carbon black.

### (Pigment Dispersion Liquid B-5)

The pigment dispersion liquid B-5 is obtained in the same manner as in the pigment dispersion liquid B-1, provided that the amount of the peroxodisulfate is changed to 0.40 mmol/m² per unit surface area of the carbon black.

### (Pigment Dispersion Liquid B-6)

The pigment dispersion liquid B-6 is obtained in the same manner as in the pigment dispersion liquid B-1, provided that the treatment time by the ultrafiltration membrane is changed to 10 minutes.

### (Pigment Dispersion Liquid B-7)

The pigment dispersion liquid B-7 is obtained in the same manner as in the pigment dispersion liquid B-1, provided that the treatment time by the ultrafiltration membrane is changed to 20 minutes.

### (Pigment Dispersion Liquid B-8)

The pigment dispersion liquid B-8 is obtained in the same manner as in the pigment dispersion liquid B-1, provided that the treatment time by the ultrafiltration membrane is changed to 40 minutes.

### (Pigment Dispersion Liquid B-9)

The pigment dispersion liquid B-9 is obtained in the same manner as in the pigment dispersion liquid B-1, provided that the treatment time by the ultrafiltration membrane is changed to 60 minutes.

The amount of the carboxyl group on the surface of the carbon black (μmol/m²) is evaluated in a following manner for the pigment dispersion liquid B-1 to the pigment dispersion liquid B-9, respectively. The result is shown in Table 1.

2 g to 5 g of the carbon black are added into 0.5 dm³ of sodium hydrogen carbonate aqueous solution having concentration of 0.976 mol/dm³, and then the solution is shook for 6 hours to obtain reaction solution. The carbon black is divided from the reaction solution by filtration. 0.05 mol/dm³ of hydrochloric acid aqueous solution is added in the filtrate. Then, quantity of the carboxyl group is determined by neutralization titration using 0.05 mol/dm³ of sodium hydroxide. This quantitative value is divided by the nitrogen adsorption specific surface area, i.e. N2SA (m²/g), of the carbon black to obtain the amount of the carboxyl group on the surface of the carbon black (μmol/m²).

In addition, the electric conductivity of the pigment dispersion liquid B, wherein the concentration of the carbon black dispersed is adjusted to 20% by mass, is measured in reference to JIS K 0130 at 25° C. using electric conductivity measuring machine, CM-30R manufactured by DKK-TOA CORPORATION. The result is shown in Table 1.

### Example 1 to 10

### Comparative example 1 to 6

### —Preparation of the Inkjet Recording Ink—

Each of the inkjet recording ink is prepared in accordance with a prescription described below, using the pigment dispersion liquid A and the pigment dispersion liquid B, wherein each of the pigment dispersion liquid is obtained in aforementioned manner. After mixing materials of the prescription for 30 minutes, mixture is subjected to a treatment of filtration, using membrane filter having pore diameter of 0.8 μm, and vacuum deaeration to obtain the inkjet recording ink.

Pigment dispersion liquid A+Pigment dispersion liquid B . . . 40.0%

(The ratio of the pigment dispersion liquid A and the pigment dispersion liquid B is shown in Table 1.)

Glycerin . . . 8.5%

3-Methyl-1,3-butandiol . . . 17.0%

2-Ethyl-1,3-hexanediol . . . 2.0%

2-Pyrolidone . . . 2.0%

Silicone modified acrylic resin, having solid content of 30% . . . 2.0%

Fluorochemical surfactant, FS-300, manufactured by E.I. du Pont de Nemours and Company, having 40% of effective ingredient . . . 2.5%

Antiseptic and antifungal agent, Proxel LV, manufactured by Avecia Inc. 0.05%

Triethanolamine 0.6%

Purified water remaining amount

The percentage amounts described above are mass percentages.

### <Volume Average Particle Diameter and Standard Deviation>

The volume average particle diameter (D50) and standard deviation of the inkjet recording ink are measured by a particle distribution measuring apparatus UPA150EX, manufactured by NIKKISO CO., LTD. Table 2 shows the results.

Further, an image is recorded on the plain paper, PPC Paper 4200, manufactured by Fuji Xerox Co., Ltd., and the gloss paper, “Gasai”, which is an extra glossy inkjet paper manufactured by FUJIFILM Corporation, using inkjet printer GX5000, manufactured by Ricoh Company, Ltd., to evaluate the image density and the jetting stability. Table 2 shows the evaluation results.

### <Image Density>

The image density of a solid image on the plain paper or the gloss paper is measured using X-Rite densitometer, manufactured by X-Rite Inc. Briefly, image density is evaluated using the procedure described by operation Manual of the densitometer, which is hereby incorporated by reference.

### <Jetting Stability>

After printing using the respective inkjet recording ink, the printer is left in a state that the printer head is capped, at 40° C. for 1 month. Briefly, jetting stability is evaluated using inkjet printer model number GX5000, manufactured by Ricoh Company.

Subsequently, the jetting stability is evaluated based on the number of cleaning operations, which the ink-ejection level of the printer is recovered to the initial ink-ejection level.

### [Evaluation Criteria]

A: Ink-ejection level is recovered to the initial level with zero cleaning time

B: Ink-ejection level is recovered to the initial level with one cleaning time

C: Ink-ejection level is recovered to the initial level with two or three cleaning times

D: Ink-ejection level is not recovered to the initial ink-ejection level even with four or more cleaning times

### <Preservation Stability>

Each inkjet recording ink is placed and sealed in a polyethylene container and then stored at 70° C. for three weeks. Thereafter, the particle diameter, the surface tension, and the viscosity of the inkjet recording ink are respectively measured. The change rate in physical properties from the initial physical properties is calculated.

The Preservation Stability is evaluated based on the following evaluation criteria.

### [Evaluation Criteria]

A: The change rate in physical properties is less than 5% in all the evaluation items of the particle diameter, the surface tension, and the viscosity.

B: The change rate in physical properties is less than 10% in all the evaluation items of the particle diameter, the surface tension, and the viscosity.

C: The change rate in physical properties is less than 30% in all the evaluation items of the particle diameter, the surface tension, and the viscosity.

D: At least one evaluation item of the particle diameter, the surface tension, or the viscosity had a change rate in physical properties of 30% or more.

TABLE 1

| | | | | Amount | |
|---|---|---|---|---|---|
| | | | | of | |
| | | | Ratio of | Carboxyl | |
| | | | Pigment | Group of | |
| | | | Dispersion | Pigment | Electric |
| | | | Liquid | Dispersion | Conductivity |
| | Pigment | Pigment | (A)/Pigment | Liquid | in Pigment |
| | Dispersion | Dispersion | Dispersion | (B) | Dispersion |
| | Liquid | Liquid | Liquid | (μmol/ | Liquid (B) |
| | (A) | (B) | (B) | m²) | (mS/cm) |
| Ex. 1 | A-1 | B-1 | 60/40 | 3.6 | 1.08 |
| Ex. 2 | A-1 | B-3 | 60/40 | 2.1 | 1.02 |
| Ex. 3 | A-1 | B-4 | 60/40 | 4.8 | 1.26 |
| Ex. 4 | A-1 | B-6 | 60/40 | 3.8 | 2.06 |
| Ex. 5 | A-1 | B-7 | 60/40 | 3.7 | 1.78 |
| Ex. 6 | A-1 | B-8 | 60/40 | 3.6 | 0.68 |
| Ex. 7 | A-1 | B-9 | 60/40 | 3.5 | 0.56 |
| Ex. 8 | A-1 | B-1 | 85/15 | 3.6 | 1.08 |
| Ex. 9 | A-1 | B-3 | 85/15 | 2.1 | 1.02 |
| Ex. 10 | A-1 | B-4 | 85/15 | 4.8 | 1.26 |
| Comp. | A-1 | B-2 | 60/40 | 1.7 | 0.98 |
| Ex. 1 | | | | | |
| Comp. | A-1 | B-5 | 60/40 | 5.3 | 1.32 |
| Ex. 2 | | | | | |
| Comp. | A-1 | None | 100/0 | — | — |
| Ex. 3 | | | | | |
| Comp. | None | B-1 | 0/100 | 3.6 | 1.08 |
| Ex. 4 | | | | | |
| Comp. | A-2 | B-1 | 60/40 | 3.6 | 1.08 |
| Ex. 5 | | | | | |
| Comp. | A-2 | B-1 | 85/15 | 3.6 | 1.08 |
| Ex. 6 | | | | | |

TABLE 2

| | Volume | Standard | Image | Image | | |
|---|---|---|---|---|---|---|
| | Average | Deviation | Density | Density | Jet- | Preser- |
| | Particle | of | on | on | ting | vation |
| | Diameter | Particle | Plain | Gloss | Sta- | Sta- |
| | (D50: nm) | Diameter | Paper | Paper | bility | bility |
| Ex. 1 | 122.6 | 48.2 | 1.36 | 1.84 | A | A |
| Ex. 2 | 126.2 | 49.6 | 1.38 | 1.85 | B | B |
| Ex. 3 | 124.6 | 51.2 | 1.37 | 1.86 | A | A |
| Ex. 4 | 141.3 | 67.2 | 1.40 | 1.88 | B | B |
| Ex. 5 | 126.8 | 52.2 | 1.38 | 1.85 | B | B |
| Ex. 6 | 120.4 | 46.3 | 1.28 | 1.82 | A | A |
| Ex. 7 | 121.8 | 45.8 | 1.24 | 1.82 | A | A |
| Ex. 8 | 126.4 | 50.4 | 1.31 | 1.87 | A | A |
| Ex. 9 | 128.6 | 51.2 | 1.34 | 1.88 | B | B |
| Ex. 10 | 127.3 | 53.3 | 1.33 | 1.89 | A | A |
| Comp. | 172.4 | 86.3 | 1.30 | 1.68 | D | D |
| Ex. 1 | | | | | | |
| Comp. | 136.2 | 62.4 | 1.28 | 1.82 | B | C |
| Ex. 2 | | | | | | |
| Comp. | 124.5 | 50.2 | 1.12 | 1.86 | B | B |
| Ex. 3 | | | | | | |
| Comp. | 110.1 | 39.8 | 1.37 | 1.58 | A | A |
| Ex. 4 | | | | | | |
| Comp. | 124.2 | 49.6 | 1.18 | 1.83 | B | C |
| Ex. 5 | | | | | | |
| Comp. | 128.6 | 51.2 | 1.05 | 1.86 | C | D |
| Ex. 6 | | | | | | |

Each inkjet recording ink of the example 1 to 10 has higher image density in printing on the plain paper and the gloss paper, and has higher property in relation to the jetting stability and the preservation stability than that of the comparative example 1 to 6.

When a range is given herein all intermediate integer and non-integer values within the described range are included as well as subranges within a described range.

What is claimed is:

1. An inkjet recording ink comprising:
water;
a dispersant containing a block type copolymer having structural unit of a diene monomer and an aromatic vinyl monomer, wherein the block type copolymer has a sulfonic acid group or salt thereof;
a first carbon black; and
a second carbon black having 2.0 μmol/m² to 5.0 μmol/m² of a carboxyl group on a surface thereof.

2. The inkjet recording ink according to claim 1, comprising,
a first pigment dispersion liquid containing water, the dispersant and the first carbon black, and
a second pigment dispersion liquid containing water and the second carbon black,
wherein the second pigment dispersion liquid has an electron conductivity of 0.6 mS/cm to 1.8 mS/cm.

3. The inkjet recording ink of claim 1, wherein the average primary particle diameter of the first carbon black ranges from 10.0 nm to 30.0 nm and the BET specific surface area of the first carbon black ranges from 100 m²/g to 400 m²/g.

4. The inkjet recording ink of claim 1, wherein the dispersant is a sulfonated block polymer or salt thereof having a mol ratio of isoprene monomer to styrene monomer ranging from 45/55 to 20/80.

5. The inkjet recording ink of claim 1, wherein the second carbon black has 3.5 μmol/m² to 4.8 μmol/m² of the carboxyl group on the surface thereof.

6. The inkjet recording ink of claim 1, the ratio of the first carbon black to the second carbon black is 85:15 to 60:40 by mass.

7. The inkjet recording ink made by a process comprising:
dispersing a first carbon black and a dispersant into water to obtain a first pigment dispersion liquid by wet dispersion treatment of the first carbon black, the dispersant, and water, and
dispersing a second carbon black into water to obtain a second pigment dispersion liquid, wherein the second pigment dispersion liquid has an electron conductivity of 0.6 mS/cm to 1.8 mS/cm.

8. The inkjet recording ink of claim 7 which is made by a process further comprising mixing the first pigment dispersion liquid and the second pigment dispersion liquid.

9. A substrate comprising the inkjet recording ink of claim 1.

10. A substrate that is plain paper comprising the inkjet recording ink of claim 1.

11. A substrate that is glossy paper comprising the inkjet recording ink of claim 1.

12. A composition produced by drying or curing the inkjet recording ink of claim 1 or by drying or curing said inkjet recording ink on a substrate.

13. A printed substrate comprising the inkjet recording ink of claim 1 or an inkjet recording ink produced by drying or curing the inkjet recording ink of claim 1.

14. The printed substrate of claim 13 that is paper.

15. An ink cartridge comprising:
a container containing the inkjet recording ink as defined in claim 1.

16. An image forming device comprising:
the ink cartridge as defined in claim 15;
and an ink ejector for ejecting the inkjet recording ink to form an image.

17. A method for forming an image on a substrate comprising applying the inkjet recording ink to a substrate using the image-forming device according to claim 16.
